(19) United States
(12) Patent Application Publication
(10) Pub. No.: US 2010/0224021 A1
(43) Pub. Date: Sep. 9, 2010

(54) ROTARY JOINT AND MANIPULATOR USING THE SAME

(75) Inventors: BO LONG, Shenzhen City (CN); XIAO-MING XU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/417,847

(22) Filed: Apr. 3, 2009

(30) Foreign Application Priority Data
Mar. 9, 2009 (CN) 200910300755.2

(51) Int. Cl. B25J 18/04; B25J 17/00

(52) U.S. Cl. 74/490.01; 74/490.05

(57) ABSTRACT

A rotary joint for connecting a mechanical arm and a connecting member, includes a first bearing ring, a second bearing ring fixed on the second bearing ring to connect to the mechanical arm, a connecting flange sleeved on the first bearing ring and the second bearing ring to connect to the connecting member, and a plurality of rolling bearings disposed between the connecting flange and the first bearing ring and the second bearing ring.

### BACKGROUND

1. Technical Field

The present disclosure relates to rotary joints, and particularly, to a rotary joint for use in a manipulator of industrial robots.

2. Description of the Related Art

Industrial robots are widely used in various applications to greatly reduce the burden of factory workers. A manipulator is an important component of the industrial robot. A typical manipulator includes a mechanical arm, a typical rotary joint, and a mechanical hand. The typical rotary joint interconnects the mechanical arm with the mechanical hand to control the rotary movement of the mechanical hand. The mechanical hand is capable of clamping a workpiece. The typical manipulator can move the workpiece from one place to another by rotary movement of the mechanical hand.

The typical rotary joint includes two connecting flanges, and a bearing assembled between the two connecting flanges. Each connecting flange has an International Organization for Standardization (“ISO”) mechanical interface for connecting any kind of ISO members, such as the mechanical hand, and the mechanical arm. However, the two connecting flanges tend to become bulky and complicated.

What is needed, therefore, is a new rotary joint to overcome the above-described shortcomings.

### BRIEF DESCRIPTION OF THE DRAWINGS

Many aspects of the present rotary joint and manipulator using the same can be better understood with reference to the following drawings. The components in the drawings are not necessarily drawn to scale, the emphasis instead being placed upon clearly illustrating the principles of the present rotary joint and manipulator using the same. Moreover, in the drawings, like reference numerals designate corresponding parts throughout the several views.

FIG. 1 is an isometric view of an embodiment of a rotary joint assembled to a mechanical arm.

FIG. 2 is an exploded, isometric view of the rotary joint shown in FIG. 1.

FIG. 3 is a partial, cross-sectional view of the rotary joint of FIG. 1 taken along line III-III.

### DETAILED DESCRIPTION OF THE EMBODIMENTS

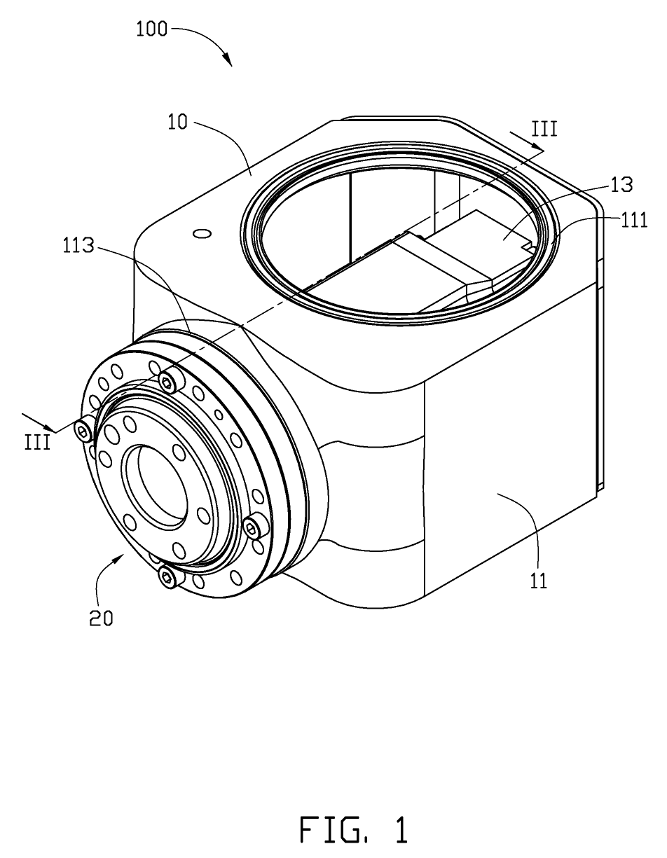

Referring to FIG. 1, an embodiment of a manipulator 100 includes a mechanical arm 10, an embodiment of a rotary joint 20, and a connecting member (not shown). The connecting member is rotatably connected to the mechanical arm 10 via the rotary joint 20. The connecting member can be a mechanical hand, or other tools such as a soldering gun, a holding member, a grinder, a welding torch or a cutter.

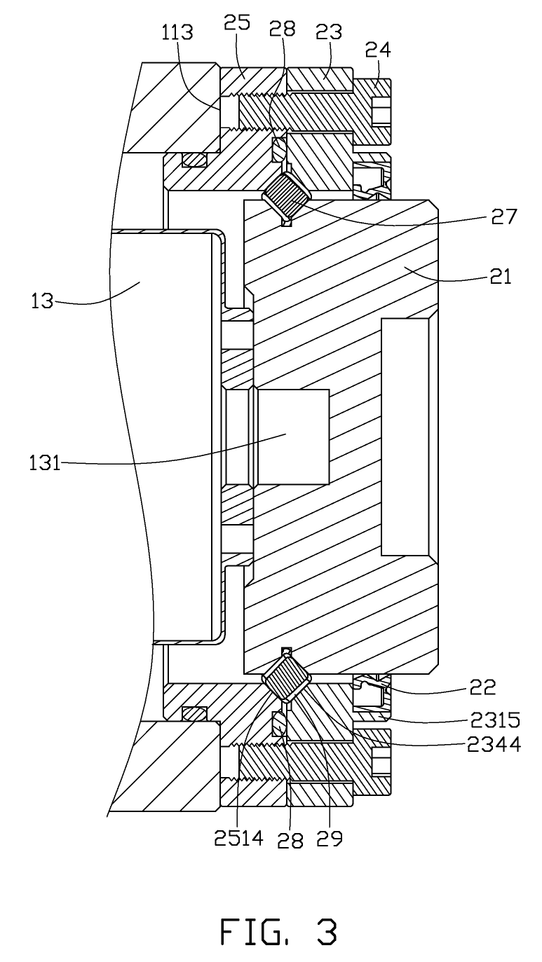

The mechanical arm 10 includes a housing 11 and a server motor 13 assembled in the housing 11. The housing 11 may be substantially cuboid shaped. The housing 11 defines a first engaging opening 111 and a second engaging opening 113. The first engaging opening 111 is located in a top surface of the housing 11 for cables (not shown) to pass through and connect to the server motor 13. The second engaging opening 113 is located in a front surface of the housing. The server motor 13 includes a rotary shaft 131 (shown in FIG. 3).

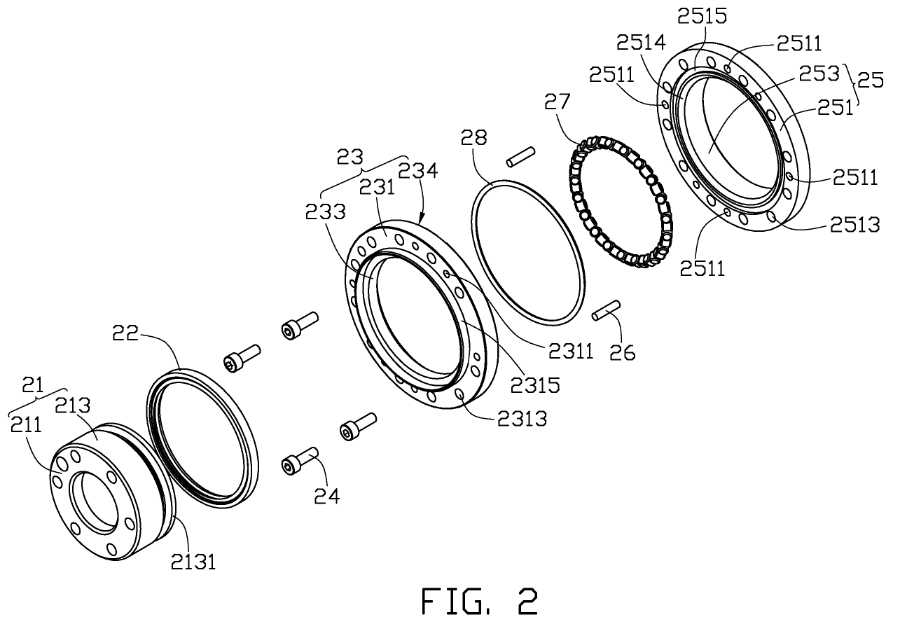

Referring to FIGS. 2 and 3, the rotary member 20 includes a connecting flange 21, a first bearing ring 23, a second bearing ring 25, and a plurality of rolling bearings 27. The first and second bearing rings 23, 25 sleeve a part of the connecting flange 21 and the rolling bearings 27, with the rolling bearings 27 disposed between the connecting flange 21, and the first and second bearing rings 23, 25. The rotary member 20 further includes a plurality of pins 26 and a plurality of fasteners 24 to fix the first and second bearing rings 23, 25 together.

The connecting flange 21 may be substantially columnar shaped. The connecting flange 21 includes a mechanical interface 211 and a side surface 213 adjoining the mechanical interface 211. The mechanical interface 211 complies with ISO 9409-1. Thus, any kind of International Organization for Standardization (“ISO”) connecting members can be connected to the mechanical interface 21 of the rotary joint 20. The connecting flange 21 further defines a V-shaped annular groove 2131 at the side surface 213 to receive the rolling bearings 27.

The first bearing ring 23 has a first end surface 231, a second end surface 234 opposite to the first end surface 231, and an inner surface 233 interconnecting the first end surface 231 with the second end surfaces 234. The first bearing ring 23 defines a plurality of through holes 2311 and a plurality of positioning holes 2313. The first bearing ring 23 further includes a restricting annular protrusion 2315 extending from the first end surface 231 adjacent to an inner edge of the first end surface 231. The first bearing ring 23 also has a first chamfer surface 2344 (see FIG. 3) defined at the inner edge of the second end surface 234. The first chamfer surface 2344 forms a first acute angle with the inner surface 233. In one embodiment, the first acute angle is 45 degrees.

The second bearing ring 25 has an end surface 251 facing the first bearing ring 23 and an inner surface 253. The second bearing ring 25 defines a plurality of fastener holes 2511 and a plurality of positioning holes 2513 in the end surface 251. Each of the fastener holes 2511 corresponds to the through holes 2311. Each of the positioning holes 2513 corresponds to the positioning holes 2313 of the first bearing ring 23. The second bearing ring 25 is similar to the first bearing ring 23, except that the second bearing ring 25 defines an annular depression 2515 in the end surface 251. The second bearing ring 25 also has a second chamfer surface 2514 at the inner edge of the end surface 251. The second chamfer surface 2514 forms a second acute angle with the inner surface 253. In one embodiment, the second acute angle is 45 degrees.

The rotary joint 20 is assembled by first placing the second bearing ring 25 on a horizontal worktable (not shown). The connecting flange 21 is assembled into the second bearing ring 25 with the V-shaped annular groove 2131 facing the second chamfer surface 2514. The rolling bearings 27 are inserted into the V-shaped annular groove 2131. The first bearing ring 23 is fixed to the second bearing ring 25 with the pins 26 passing through the corresponding positioning holes 2313 and 2513, and the fasteners 24 engaged in the corresponding fastener holes 2511. Finally, the V-shaped annular groove 2131 of the connecting flange 21, the first chamfer surface 2344 of the first bearing ring 23, and the second chamfer surface 2514 of the second bearing ring 25 cooperatively form an annular sliding channel 29 to receive the rolling bearings 27. In one embodiment, the rolling bearings 27 are columnar roller bearings arranged in a predetermined manner, such as in a stagger manner (see FIG. 2). In alternative embodiments, the rolling bearing 27 can be ball bearings, needle bearings, and so on. In addition, the rolling bearings 27 may be treated with lubricating oil to decrease friction.

In one embodiment, the rotary joint 20 further includes a first sealing ring 22 and a second sealing ring 28. The first sealing ring 22 is disposed between the restricting annular protrusion 2315 and the side surface 213 of the connecting flange 21, to prevent the lubricating oil of the rolling bearings 27 from leaking through a gap between the side surface 213 of the connecting flange 21 and the first bearing ring 23. The second sealing ring 28 is positioned in the annular depression 2515 to prevent the lubricating oil of the rolling bearings 27 from leaking through a gap between the first bearing ring 23 and the second bearing ring 25.

In use, the second bearing ring 25 is fixed to the mechanical arm 10. The rotary shaft 131 of the server motor 13 is rotatably fixed to the connecting flange 21 of the rotary joint 20 via the second engaging opening 113. The connecting member is assembled to the mechanical interface 211 of the connecting flange 21 of the rotary joint 20. Thus, the connecting member is rotatable because of the rotary movement of the server motor 13.

It is to be understood that the annular depression 2515 can be formed in the second end surface 234 of the first bearing ring 23 to receive the second sealing ring 28. In addition, the first bearing ring 23 can be fixed to the second bearing ring 25 by welding or glue.

It should be pointed out that the rotary joint may not only be used in the manipulator 100, but also, for example, in automobiles.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A rotary joint for connecting a mechanical arm and a connecting member, comprising:
a first bearing ring;
a second bearing ring to connect to the mechanical arm, wherein the first bearing ring is fixed on the second bearing ring;
a connecting flange to connect to the connecting member, wherein the connecting flange is sleeved on the first bearing ring and the second bearing ring; and
a plurality of rolling bearings disposed between the connecting flange and the first bearing ring and the second bearing ring.

2. The rotary joint of claim 1, wherein the connecting flange comprises a mechanical interface, a side surface adjoining the mechanical interface, and a V-shaped annular groove defined at the side surface.

3. The rotary joint of claim 2, wherein the first bearing ring comprises a first end surface, a second end surface opposite to the first end surface, an inner surface interconnecting the first end surface with the second end surface, and a first chamfer surface defined at an inner edge of the second end surface, the first chamfer surface forming a first acute angle with the inner surface thereof.

4. The rotary joint of claim 3, wherein the second bearing ring comprises an end surface facing the first bearing ring, an inner surface, and a second chamfer surface defined at the inner edge of the end surface, the second chamfer surface forming a second acute angle with the inner surface thereof.

5. The rotary joint of claim 4, wherein the V-shaped annular groove of the connecting flange, the first chamfer surface of the first bearing ring, and the second chamfer surface of the second bearing ring cooperatively form an annular sliding channel to receive the rolling bearings.

6. The rotary joint of claim 4, wherein the first bearing ring defines a plurality of through holes and a plurality of positioning holes therein; the second bearing ring defines a plurality of fastener holes corresponding to the through holes of the first bearing ring, and a plurality of positioning holes defined in the end surface thereof corresponding to the positioning holes of the first bearing ring; the rotary joint further comprises a plurality of fasteners and pins; the first bearing ring is fixed to the second bearing ring with the pins passing through the corresponding positioning holes and the fasteners engaged in the corresponding fastener hole.

7. The rotary joint of claim 3, wherein the first bearing ring further comprises a restricting annular protrusion extending from the first end surface adjacent to an inner edge of the first end surface thereof.

8. The rotary joint of claim 7, wherein the rotary joint further comprises a first sealing ring disposed between the restricting annular protrusion and the side surface of the connecting flange to prevent lubricating oil of the rolling bearings from leaking through a gap between the side surface of the connecting flange and the first bearing ring.

9. The rotary joint of claim 4, wherein the second bearing ring further defines an annular depression at the end surface thereof.

10. The rotary joint of claim 9, wherein the rotary joint further comprises a second sealing ring positioned in the annular depression to prevent lubricating oil of the rolling bearings from leaking through a gap between the first bearing ring and the second bearing ring.

11. The rotary joint of claim 5, wherein the rolling bearings are selected from a group consisting of columnar roller bearings, ball bearings and needle bearings.

12. The rotary joint of claim 11, wherein the rolling bearings are columnar roller bearings arranged in a stagger manner.

13. A manipulator, comprising:
a mechanical arm;
a connecting member; and
a rotary joint, the rotary joint comprising:
a first bearing ring,
a second bearing ring fixed to the mechanical arm, wherein the first bearing ring is fixed on the second bearing ring;
a connecting flange connected to the connecting member, wherein the connecting flange is sleeved on the first bearing ring and the second bearing ring; and
a plurality of rolling bearings disposed between the connecting flange and the first bearing ring and the second bearing ring.

14. The manipulator of claim 13, wherein the connecting flange comprises a mechanical interface, a side surface adjoining the mechanical interface, and a V-shaped annular groove defined at the side surface.

15. The manipulator of claim 14, wherein the first bearing ring comprises a first end surface, a second end surface opposite to the first end surface, an inner surface interconnecting the first end surface with the second end surface, and a first chamfer surface defined at an inner edge of the second end surface, the first chamfer surface forming a first acute angle with the inner surface thereof.

16. The manipulator of claim 15, wherein the second bearing ring comprises an end surface facing the first bearing ring, an inner surface, and a second chamfer surface defined at the inner edge of the end surface, the second chamfer surface forming a second acute angle with the inner surface thereof.

17. The manipulator of claim 16, wherein the V-shaped annular groove of the connecting flange, the first chamfer surface of the first bearing ring, and the second chamfer surface of the second bearing ring cooperatively form an annular sliding channel to receive the rolling bearings.

18. The manipulator of claim 17, wherein the rolling bearings are selected from a group consisting of columnar roller bearings, ball bearings and needle bearings.

19. The manipulator of claim 18, wherein the rolling bearings are columnar roller bearings arranged in a stagger manner.
